(19) United States
(12) Patent Application Publication
(10) Pub. No.: US 2004/0260645 A1
(43) Pub. Date: Dec. 23, 2004

(54) [Method and System for Charity Associated Marketing]

(76) Inventor: Marvin Yakos, Rexford, MT (US)

Correspondence Address: JOEL I ROSENBLATT, 445 11TH AVENUE, INDIALANTIC, FL, 32903, US

(21) Appl. No.: 10/604,004

(22) Filed: Jun. 20, 2003

(51) Int. Cl. G06F 17/60

(52) U.S. Cl. 705/39; 705/30

(57) ABSTRACT

A system for identifying customers and their purchases with organizations with a cause designated to receive a part of the customer“s purchase amount as a credit. The method uses the system to identify customers with their respective organizations with a cause and then records all transactions between the customer and the respective organization with a cause and allocates credits to the system, the organization with a cause, other participants such as account managers and computes the credits with respect to separate algorithms for each of the marketing distribution levels associated with a transaction.

### BACKGROUND OF INVENTION

Fund raising for charities, organizations or other worthwhile causes has always been a well known respected and wide spread practice. People enjoy sharing their wealth with a worthwhile cause through an organization that is able to function only because of its ability to assemble sufficient capital to adequately fund small or large scale relief and other charitable projects.

One of the most persistent difficulties in charity work and raising the monetary funds to defray its costs has been first, reaching out to and making meaningful contact with that large pool within our population who are disposed to share their wealth with worthwhile organizations, and then providing a simple and effective way for these charity donors to donate at this critical time when they are otherwise involved in a monetary transaction. It is at this critical time, when a money transaction is taking place, that people are more likely to be in a frame of mind conducive to charity giving. It is at this critical time that it is most productive to connect the potential donation with those charitable and other worthy organizations, and it is at this time that the party making the purchase is most interested in or favorably disposed toward.

There currently exist many varied systems and methods for connecting a sale with a commission and crediting of that commission to a sales person or other referring entity such as for example, a website with a link to a merchant's Internet site. These systems and methods may include, for examples, record keeping for accumulating the amount or quality of purchases from a selling agent's or other referring web site and for the tallying of commissions or other payments.

However, these existing systems and methods do not provide for a potential buyer of goods or services to make or change an association with an organization worthy of their charitable donation or for establishing more than one level of merchant, donation receiver and donating party or for system wide overviews for more than one level of referring party, and for system wide supervision by a central controlling administrator.

### SUMMARY OF INVENTION

For use in describing the invention according to the disclosed inventive principles and as shown in a preferred embodiment, the inventive system is referred to as the “JoBasic” method and system for charity associated marketing or the “JoBasic system,” for the purposes of explanation, only to refer in this application to the inventive system and method for charity associated marketing. JoBasic is a service mark intended for use with the provision of the JoBasic services and in accordance with applicable U.S. trademark law.

Today's economy has created an enormous need for a fund raising vehicle with integrity and long term residual income. Churches, various charities, booster clubs, and a variety of fund raising organizations require it. Consumers want and need a trusted home, a place where they can shop securely and simultaneously support their favorite causes. Vendors vie for and welcome an expanded marketplace. Thousands of affiliates, account mangers, networkers, distributors and marketing partners will help build a business they can be proud to promote with no outlay of capital, state of the art marketing/accounting tools and ongoing residual opportunities.

To meet the challenges of a multi-tiered merchandising and commission referral system coupled with direct fund_raising for those organizations deemed worthy on an individual personal preference basis, the method and system provide for an operation that can function on multi and expanding tiers, including a three tiered and/or multi-tiered system. One level can be for website marketing partners or organizations with two or more sub levels for regional director, account managers, networkers, distributors or marketing partners. The method and system include means for accounting for each respective sale, by each respective account manager or regional director or marketing partner connected with the sale, at the merchant level and the purchaser/donator level so commissions or other related payments are immediately and correctly credited and the correct respective affiliate's account is updated responsive to the purchase and donation level, for an automatically generated commission for each affected system participant, whether directly or indirectly related, or active in or passive, or at different credit levels, with respect to each related website or JoBasic system transaction.

To facilitate the construction of the data base used to recognize, and deliver purchases, and credits for affiliates, at the correct levels, control of the central administrative website may be centralized or distributed the account managers, distributors, networkers, regional directors or marketing partners so an on line process may be easily implemented for registering those potential purchases who are interested in and would use a convenient system for making directed donation while adding to the efficiency of the process by making it part of a commonly occurring money transaction.

Through a central administrative JoBasic website, and an associated Admin Panel, as shown in a preferred embodiment, the account manager, distributor, networker, regional director or marketing partner online sign up process is spread throughout the system with respect to an ID number for tracking purposes and account history accessible by means of a user name and a password or other suitable identification.

In illustration of the multi-tiered system and method, through the central administration website, sales, purchasers, merchants, affiliates, account managers, networkers, regional directors, distributors or marketing partners and the quality or level of the sale and the purchaser selected which organization to receive the credit or donation, credits may be allocated on one or at least two or more levels or as many as deemed necessary. On a first level, merchants selling directly from their website receive a seller's credit. The affiliates, account managers, distributors, networkers, regional directors, and/or marketing partners associated with the selling merchant's website receive a credit for a purchase by a related donor or worthy organization donee. Additionally the system and method must have the capacity to immediately recognize affiliate, distributor, regional, account manager, networkers, marketing partners at multi-levels to accommodate discrete levels of responsibility or accomplishment and to credit each respective level and/or marketing partner correctly for the respective levels achieved, in real time or cumulatively as those levels change.

At the center of the system is the Administrative Panel (Admin Panel), which can be arranged into separate secure data base sections to accommodate each system participant, for example each affiliate, distributor, regional, account manager, networker, and/or marketing partner's records. As the system is arranged to be multi-tiered, the Administrative Panel is accessible to Regional Operating Directors, (ROD) arranged into separate secure data base sections with access to the separate distinct Account Manager, distributor, networker, or marketing partner sections assigned to each respective Regional Director, supervisor, or head administrator. As each affiliate, distributor, ROD regional director, account manager, networker, or marketing partner adds respective Organizations with Worthy Cause (“OWC”) to the JoBasic system, the related data for each respective party associated therewith, may be placed in the Administrative Panel data base section or the JoBasic system controller web site or other data base accessible to the JoBasic system, as described above.

At the center or core of the JoBasic(sm) system is the JoBasic web site server which serves as a system website which is used to register customers who are interested in making purchases that will benefit the OWCs. “JoBasic” is a service mark and is used for reference only in this application to refer to the invention used in connection with the advertising or provision of the JoBasic services. JoBasic is capitalized to indicate its service mark status. In a preferred embodiment, a Customer can register in the JoBasic system directly through the JoBasic website or through the OWC ReplaCustom website created by the Account Manager, distributor, marketing partner, networker and/or regional director in the Administrative Panel data base.

The system can accommodate multi-tiered product and service vendors on at least two or more separate levels. Within the JoBasic system are Preferred Vendors and Associate Vendors. Purchases through Preferred Vendors are made directly from the JoBasic website or from a respective OWC ReplaCustom website. Purchases through an Associate Vendor are made through a link from the JoBasic web site to the Associate Vendor's web site. The JoBasic system includes means for assessing of web sites within the system, logged or registered in the Admin Panel data base or another respective means for accounting of the JoBasic system related transaction, including for example, accounting of all respective credits at the various discrete set levels for each of the system participants, namely, the Regional Director, Account Managers, networkers, marketing partners, distributors, JoBasic, customers, the Preferred and Associate Vendors and the OWC“s and for transaction locations at the OWC ReplaCustom websites, or at the JoBasic system website or at the Vendor websites, for example.

Means are included for direct communication with the JoBasic system Customer responsive to Customer activity or transactions. Responsive to each transaction a notice may be sent by email to the Customer identifying the vendor, the purchase and the amount of credit received by the customer's designated OWC.

The system is arranged to store separate levels of compensation for each OWC as may be negotiated for separately offered plans. For example, the customer may designate a standard rate of compensation for a designated OWC as may have been established by JoBasic or the customer, or when registering, the Customer may agree to an extra charge for the sale to be transferred by the system to the designated OWC as an extra donation recorded for the customer. Under a standard plan for example, a part of the purchase price will be credited to the OWC, the Account Manager, ROD, distributor, networker, marketing partner, and a full record maintained at the Administrative Panel, made selectively accessible to each system participant, according to suitable security passwords or other suitable means for controlling data access as would be known to those skilled in the art.

The standard plan may be varied for each vendor, distributor, partner, networker, account manager or regional director with respective to each customer and to each vendor. Additionally, the amount allotted from each purchase, whether from the purchase price or from an additional donation made by the customer, may be varied by customer or JoBasic. The separate rates for compensation allotted from each purchase are kept within the Administrative Panel which is responsive to a transaction and to the parties involved, and the system completes the accounting for each and records the result in the Administrative Panel Data Base, according to the JoBasic system procedures and algorithms and transmits notices as describe above.

In review, the JoBasic system, as shown and described in a preferred embodiment according to the disclosed inventive principles, is a computer operated marketing system to reach the end customer for a purpose. In a preferred embodiment as disclosed, the JoBasic system includes means for indicating the assignment of at least one person as a Regional operating Director (ROD), with respect to at least one respective area or region. The JoBasic system includes means for the ROD to control respective duties and responsibilities, for example and not in limitation, to select, supervise, train and oversee Account Managers. The JoBasic system includes means for Account Managers to record the selection and registration of organizations participating in marketing and promoting products and services affiliated with the JoBasic system. These organizations in a preferred embodiment are identified as Organizations with Cause (OWC). A Customer may register with the JoBasic system by means of a data entry window, which may be provided to the Customer by means of Internet communications or any other suitable telecommunications now or hereafter developed. Registration may be through the OWC ReplaCustom Website for the purpose of a percentage of the sale price going to the OWC. In a preferred embodiment, the JoBasic system includes means for a Customer to transact a purchase directly from the JoBasic Internet website or other data transmission node or terminal and select any registered OWC ReplaCustom 2 as the benefitting organization. When a registered Customer makes a purchase the OWC, the JoBasic system includes means for allocating to the respective OWC, a part of or a predetermined amount of the sale. The JoBasic system includes means for allocating to the Account Manager recorded by the JoBasic system as the party which registered the OWC, a portion of or a predetermined amount of the sale price of each transaction. The respective regional operating director (ROD) registered in the JoBasic system for that respective Account Manager will receive a part of or a predetermined amount of the sale. In a preferred embodiment, the JoBasic website includes means for controlling all aspects of the system.

In a preferred embodiment of the JoBasic system, the means for operation of the JoBasic related transactions, inclusive of the direct transactions and the indirect transactions in response to the direct transactions, including but not limited to the transactions made according to algorithms or procedures and the recording the transactions, is the Admin Panel, but as would be understood by those skilled in the art, this function may be placed in any other suitable web site or server, such as for example and without limitation, the JoBasic website. Each OWC may be assigned a respective OWC ReplaCustom website. The OWC ReplaCustom web site, according to a preferred embodiment, may be created by an Account Manager by means of control by the respective Account Manager of a respective part of the Admin Panel. The JoBasic system may include suitable security controls so each Account Manager is limited to the data entered with respect to that respective Account Manager's transactions. Accordingly, a respective Account Manager would have the means for access to view sales of the OWCs registered through the respective Account Manager from the Admin Panel. Similarly, according to the disclosed preferred embodiment, a respective OWC would have the means for full access through the Admin Panel or JoBasic system web site, for example, for viewing all transactions related to the OWC. In a similar manner, the ROD would have the means for full access to all sales from OWCs that are registered to a respective Account Manager.

The JoBasic system includes means for recording in data the transactions of a registered customer with a related respective OWC ReplaCustom Website from the initial purchase. In a preferred embodiment, the JoBasic system includes means for communication with all of the registered customers, such as for example, through electronic email and website notices. The JoBasic system includes means for communication with the customer using a respective OWC Signature which may include a link to the OWC ReplaCustom website, so the customer is connected through the Internet or other suitable telecommunications means and so the JoBasic website will be transparent.

The JoBasic system, according to a disclosed preferred embodiment, may include two types of vendor relationships, Preferred Vendors and Associate Vendors. Preferred Vendors are companies or services that are featured on or promoted from the JoBasic web site or from the OWC ReplaCustom web site or server, or for whom, transactions may be completed through the JoBasic system or OWC ReplaCustom, web site. In a preferred embodiment, an Associate Vendor has a respective web page, and the JoBasic System includes means for directing a Customer to an Associate Vendor's web site or by other telecommunications means, by an Internet address link place, for example, on the JoBasic web site or the OWC ReplaCustom web site. Means are included in the JoBasic system for recognizing and recording the connections of a Customer to an Associate Vendor web page, the customer's respective transactions and responsively, the indirect transactions with respect to the data generated according to the JoBasic system algorithms, including without limitation, the customer related sales and the percentages or commissions, or bonuses, produced in relation thereto.

In a preferred embodiment, the Admin Panel may include back office functions for the ROD, and Account Manager, for example, sign up for ROD or Account Manager, year to date commission compilations, OWC sign up for Account Manager or ROD, training material, and all other suitable market related information.

Accordingly, shown for a preferred embodiment, for the disclosed inventive principles, is a system for charity associated marketing with a system control for identifying system participants and identifying one or more customers or one or more organizations with a cause and producing and recording transaction data related to the one or more customers or said one or more organizations with a cause; interconnecting data communications; with the system control connected to the data communication for receiving transaction data indicative of transactions related to one or more customer or one or more organization with a cause, for producing credit data indicative of at least a part of said transactions to be credited to a respective system participant.

As shown in the Description of the Invention, in a preferred embodiment, a system control, for example the JoBasic web site is used to establish or coordinate data communications between a customer desiring to make a purchase in connection with or related to a customer designated organization with a cause and to credit the organization with a cause with at least a part of the transaction amount.

The system of may include processes or algorithms for producing credit data, which responsive to the marketing levels of the system participants, produces separate respective credit data for separate respective system participants or said credit data with separate respective credit allowances.

Marketing Distribution levels may refer to the proximity of the respective participants to the customer or the organization with a cause. For example, an organization with a cause identified with the JoBasic system controller, for example by a link on the system controller JoBasic web site to the organization with a cause web site, may receive a maximum credit while an organization with a cause, linked to the system control JoBasic web site by an intermediate link, such as for example an associated list of associated organizations with a cause, may receive a smaller credit. While the Internet and web sites are used in a preferred embodiment, as would be known and understood, any other suitable means of telecommunications may be used.

The system may include identified account managers participating in the enlisting of organizations with a cause or customers and which are designated to receive credit in relation to the credit data indicative of at least a part of the system related transactions.

The system, according to a preferred embodiment may include data relating the aforesaid marketing levels and the production of separate respective credit data for separate respective system participants directly producing said separate respective credit data from said transaction data or indirectly in response to said directly produced separate respective credit data. In this way, and according to the processes or algorithms used in the system marketing levels data, the credit data may be distributed or allowances made of the credit data according to commissions for example to ROD“s or account managers for their participation in the JoBasic system in enlisting customers or organizations with a cause.

The system processes or algorithms according to the marketing levels data, may be related to whether a participant is active in a transaction, as for example an organization with a cause directly participating in the operative transaction with a customer, or reacting to a transaction, for example an ROD or account manager which receives a credit in response to the transaction or the JoBasic system web site for a transaction where a customer deals directly with the organization with a cause web site without proceeding first through the JoBasic system web site. In response to the marketing level data, the production of the credit data may be separate respective credit data for separate respective system participants, including separate respective credit data in response to separate respective marketing levels.

The system marketing levels data, in a preferred embodiment, may include or produce separate respective credit data for separate respective system participants with separate respective credit allowances. For example, in a preferred embodiment, there may be production of said separate respective credit data for vendors with a preferred presence relation with one or more system participants or for vendors with an associated presence relation with one or more system participants. In a preferred embodiment, a preferred vendor, for example, may be one identified on the system control web site or on the web site of an organization with a cause and with a direct link to the preferred vendor. Or for example, in a preferred embodiment, an associate vendor may be identified indirectly with a system web site, by a secondary listing requiring at least two links to contact or may be one by the customer through separate arrangements the customer may want the JoBasic system control to administer.

By “link,” is meant the common method used to direct Internet users by means of an Internet address placed in a web page, to the web page with respect to that address, or to any other now or hereafter telecommunications process operating in substantially the same way and producing substantially the same result, and is not in limitation of the telecommunications method or system shown for a preferred embodiment.

The system may be explained in relation to system parts such as a central data processing site connected to a communications system; a customer data processing site connected to said communications system; a plurality of organizations with a cause sites connected to said communications system, the customer data processing site producing data indicative of a transaction for a designated respective organization with a cause, in response to a customer's purchase order or donation order, entered through said customer data processing site; the central data processing site, responsive to said data indicative of transaction, producing organization with a cause credit data indicative of at least a part of or percentage of the amount of said transaction credited to said designated respective organization with a cause site; and the central data processing site producing a record of said organization with a cause credit data.

In a disclosed preferred embodiment, the allowance of credit may be made responsive to assigned marketing levels for preferred vendor or associated vendor credit data related to primary and secondary communications links, as explained above.

The method of the disclosed invention according to the disclosed inventive principles as shown for a preferred embodiment may comprise the steps of identifying system participants; identifying one or more customers or one or more organizations with a cause and producing and recording transaction data related to said one or more customers or said one or more organizations with a cause; and receiving said transaction data indicative of transactions related to said one or more customers or said one or more organization with a cause, for producing credit data indicative of a part of said transactions to be credited to a respective system participant.

Producing credit data, may include producing separate respective data for separate respective system participants or said credit data with separate respective credit allowances.

Identifying system participants may include the step of identifying an account manager; and producing credit data and may include the step of producing credit data indicative of at least a part of said transactions to be credited to said account manager.

Producing separate respective credit data for separate respective system participants may include the step of producing the separate respective credit data directly from the transaction data or indirectly in response to said credit data, or for vendors with a preferred presence with one or more system participants or for vendors with an associated presence with one or more system participants, or system participants acting in said transactions and system participants reacting to said transactions.

### BRIEF DESCRIPTION OF DRAWINGS

FIG. 1 shows in a block diagram, the overall arrangement of the JoBasic system web sites and their addressable nodes and data paths through the system, as explained according to a preferred embodiment and according to the disclosed inventive principles.

FIG. 2 shows the operation of the JoBasic system by showing the flow of data between the data nodes and web site servers, as shown in FIG. 1, and with data paths identified by reference numerals used in the description of the invention.

### DETAILED DESCRIPTION

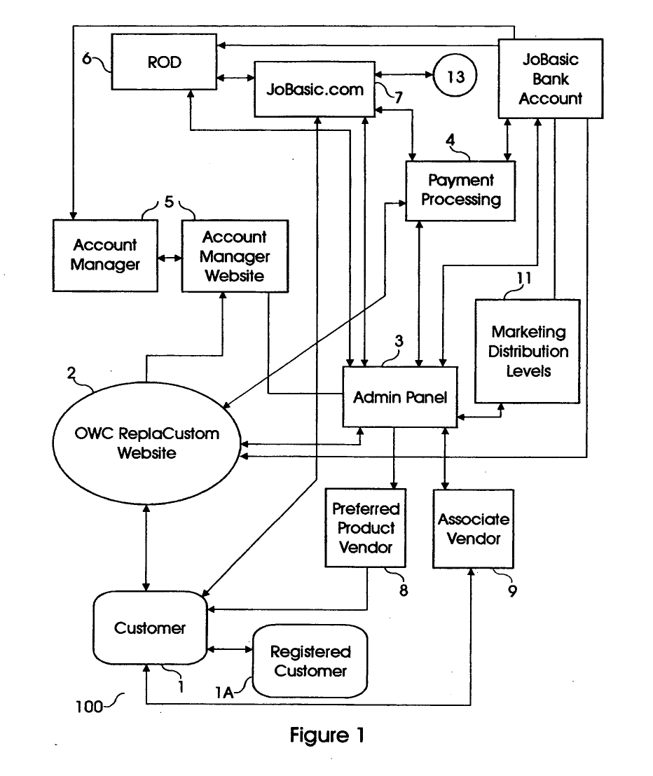

The JoBasic inventive system identified herein as the JoBasic method and System for charity associated marketing is shown generally in FIG. 1, in block form with each block representing system participants and having the functions and cross data flows as shown therein and as explained herein. At the core of the system, identified generally by numeral 100, is the JoBasic System Controller 7, serving as the JoBasic.com website. JoBasic is a registered domain name and an Internet URL which is used in establishing data links or flows, with the JoBasic.com website and through the Internet, as would be well to those skilled in the art. According to the inventive principles, the JoBasic system is divided into separate identifiable areas, for example as shown in a preferred embodiment, into demographic areas or regions, states or provinces or territories through the United States and Canada and the world.

One or more separate Internet data nodes or web site servers, as would be known to those skilled in the art, are used in the JoBasic system with at least one node identified with a defined respective parameter and for a preferred embodiment, as shown according to the disclosed inventive principles, to a defined respective region as a regional operating director (ROD) website, as identified by numeral 6. Each of the respective ROD web sites provided the functions of identifying and tracking the data activities of the respective region's Account Manager nodes or web sites, as explained herein. Within the JoBasic system, the Account Manager node or website is indicated by numeral 5. The Account Manager node or web site 5 is used for the data indicative of the account manager, and the organizations registered in the JoBasic system to participate in marketing and promoting products and services in connection with the JoBasic System Controller web site 7.

As would be apparent to those skilled in the art, the inventive system would include one or more Account Manager or networker web sites 5, for each ROD or supervisor website 6, and the inventive system would include one or more ROD web sites 6. However, for purposes of explanation, only one ROD node or website 6 and Account Manager Node or web site 5, are shown as the functions of additional ROD's or account manager, nodes or web sites would be cumulative.

The object of the JoBasic system is to provide consumers with a functional means to safely and securely shop and to support the consumers respective target organization by a financial contribution associate with a purchase or other event or even as an independent act, for example a donation. In the JoBasic system, these target organizations are identified as organizations with cause “OWC” and may have a node or web site in the Internet as would be known to those skilled in the art. These OWC nodes or web sites are identified in FIG. 1 as the OWC ReplaCustom web site and by numeral 2. Although only one OWC ReplaCustom website is shown, that web site is understood to represent a plurality of OWC ReplaCustom web sites.

The Customer is identified in FIG. 1, by numeral 1 and may be registered by a representation in data at one or more OWC ReplaCustom web sites 2, or at the JoBasic System controller web site 7. A Customer 1 registered with the JoBasic system 100, through or with the OWC ReplaCustom Website 2, will produce a defined percentage of the sale or purchase price for a transaction, being attributed or credited to that respective OWC 2. As Customer 1 may also cause a purchase to be made directly from the JoBasic system controller website 7, and may select anyone or more of the JoBasic system registered OWC's 2, as the benefitting organization, and the amount of the credit or credits for the OWC or OWC's, as the case or for the ROD“s or Account Managers, as may be established for example, by algorithms or procedures within the Admin Panel 3 or the Additional Marketing Distribution Levels 11 data base, will be made so each system participant, will receive its proper credit for a respective transaction as established or modified in the JoBasic system 100.

When a registered Customer 1 after being registered, for example through the JoBasic system registration data entry window 1A, makes a purchase, the OWC for a respective OWC ReplaCustom web site 2, associated with that Customer by its registration through the OWC ReplaCustom web site 2 or through the JoBasic system controller web site 7, or another of the JoBasic system 100 participants, that OWC will be the recipient of the predetermined amount of the sale or donation. The JoBasic registration window 1A may be used by an OWC ReplaCustom web site 2, or the JoBasic System controller web site 7 or by an ROD 6 or Account Manager 5, to register a Customer 1 with regard to the Customer“s associated OWC“s. The respective Customer information may be stored in the Admin Panel 3 and data with respect to the credits available for each system participant for each transaction, stored in the Marketing Distribution Levels 11 data base, or in a combined data base or in a data base distributed in the JoBasic system 100, as would be known by those skilled in the art.

The entire system is electronically automated and is designed to function in an automated and seamless fashion. In the preferred embodiment, recording of data produced in response to transactions is accomplished by the Admin Panel 3, and Marketing Distribution levels data base 11, shown as a separate node or web site server but which could be incorporated in any of the other nodes or web sites, with respect to the JoBasic system 100 participants, such as the ROD 6 or account manager site 5, or JoBasic.com System Controller web site 7, for example.

As would be known to those skilled in the art, the functions shown for each of the nodes or web sites may be combined or relocated, with or to other nodes or web sites in the JoBasic system, without departing from the disclosed inventive principles.

In a preferred embodiment as disclosed according to a preferred embodiment, each OWC ReplaCustom website 2 can be created by an Account Manager 5 through the Admin Panel 3 accessible to Account Manager web site 5 or directly In a preferred embodiment, an Account Manager site can be given full access to view sales through all OWC ReplaCustom web sites 2, as registered by a respective Account Manager 5 or other JoBasic system participant or networker, through Admin Panel 3, for example. In a similar manner, the OWC through its respective OWC ReplaCustom web site 2 can be given full access through the Admin Panel 3 for viewing all sales that the respective OWC is benefiting from and credits or commissions to date. The ROD 6, can be given full access to all sales from OWCs 2, that are registered to Account Managers 5, within its region. In this manner, each of JoBasic system 100 participants can be given limited access to the nodes or web sites of other related system participants to view transaction and credit records for the respective participant.

In the operation of a preferred embodiment, according to the disclosed inventive principles, each respective customer can be tracked to its respective purchases at a respective OWC ReplaCustom Website 2. Data connections made between the Customer 1, over the Internet for example, with respective OWC ReplaCustom Web sites 2, may be direct so any data transfers caused by a purchase to any other of the JoBasic system web sites or nodes occur transparently to the Customer 1 or the OWC ReplaCustom 2 web sites, so the JoBasic web site 7 remains transparent to the Customer 1.

In order to accommodate more than one level of vendor relationship the JoBasic system can separately register and account for separate transactions with respective credit levels for at least two or more types of vendors. As shown in a preferred embodiment and according to the disclosed inventive principles, the JoBasic system can accommodate a Preferred Product Vendor as indicated by numeral 8 and an Associate Vendor as indicated by numeral 9. In a preferred embodiment as according to the disclosed inventive principles, the Preferred Product Vendors 9 are registered in the Admin Panel 3 or Marketing Distribution Levels 11 data base or the data bases for the JoBasic server or web site 7, and may be associated with one or more OWC ReplaCustom servers or web sites 2.

For a Preferred Product Vendor 9, its server or website may be directly linked from the JoBasic System Controller website 7 or from one or more OWC ReplaCustom web sites, for example by a named presence and by placing an Internet URL for that Vendor website in the JoBasic system controller 7 web site, for the purpose of accessing that linked web page, as well known to those skilled in the art and for that reason is not discussed herein.

In connection with the JoBasic system inventive principles, each respective access of a linked web page is registered, in preferred embodiment, by Admin Panel 3, and for a transaction, with respect to the Payment Processing as indicated by numeral 4, for different respective marketing levels depending on the marketing distribution level as registered in the Marketing Distributing Levels node 11.

The Admin Panel 3 in a preferred embodiment is the JoBasic system 100, data processing center associated with the JoBasic system controller 7, for receiving and responsively communicating data and storing data, with respect to each transaction for each registered customer 1, the ROD 6, the Account Manager website 5, the JoBasic Website 7, the vendors shown as separate marketing distribution level vendors Preferred Product Vendor 8 and Associate Vendor 9, and with respect to the functions of Payment Processing 4, for the associated information from Marketing Distribution Levels 11 and the transfer of credits for distribution to the JoBasic OWC's and other participants.

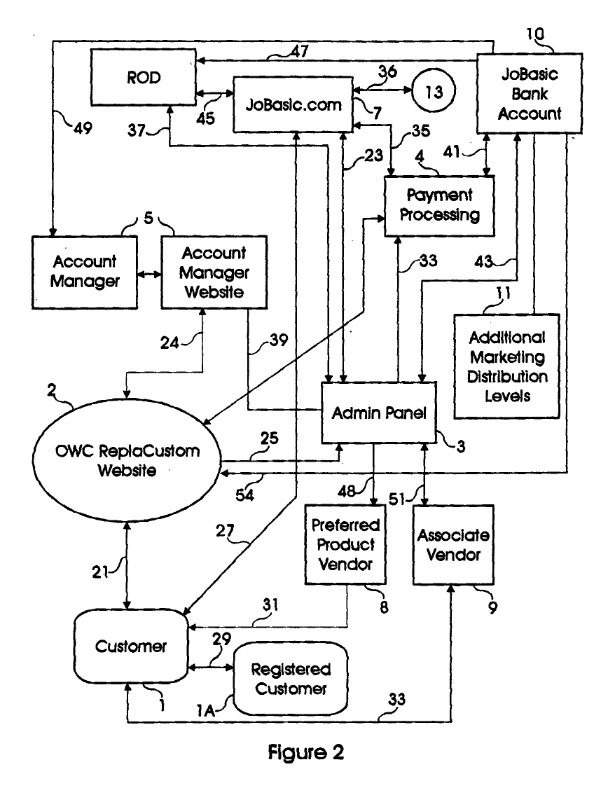

Operation of the JoBasic system is explained with reference to FIG. 2 wherein the flow of data between the system nodes or servers and web sites are referenced by the identifying numerals and described according to the disclosed inventive principles as shown in a preferred embodiment.

The operation of the JoBasic system for explanation purposes is shown starting with the registration of a Customer identified by numeral 1. As would be understood by those skilled in the art, the data flows as described are through the Internet as shown for a preferred embodiment but as would be known and understood by those skilled in the art, may be through any suitable telecommunications means now know or hereafter discovered or invented which performs substantially, the same functions in the same way to achieve the same results. The details of the data entry and transfers are not shown as would be known and understood by those skilled in the art.

Customer 1, provides identification information in the form of data through direct Internet data path 27 to the JoBasic.com System Controller web site server 7, or through an OWC ReplaCustom web site 2, by data path 21, shown here in a preferred embodiment or in a data path 25 from the OWC ReplaCustom 2 web site to Admin Panel 3 or through the JoBasic system controller 7 web site to Admin Panel 3 by data path 23 to the Admin Panel 3, or in any other suitable data path to a data base which may be distributed in the JoBasic system 100, and as would be known and understood by those skilled in the art. These examples of how the JoBasic system 100 may enroll a Customer 1, are shown for a preferred embodiment and are not limiting of the disclosed inventive principles and enrollment may be by any JoBasic system participant.

The Customer 1, information would be provided through a data entry window 1A, for example, for at least some Registered Customers 1, as transmitted through data path 29, to the Customer 1 responsively to a request to become a registered customer, and which may originate in one or more of the JoBasic system 100 participant web sites as would be known by those skilled in the art. The data requested by the JoBasic system 100 of the Customer 1 in order to become a Registered Customer, would include the Customer's 1, name, address, phone number, the method of payment, and any other information that would be relevant, such as for example, shopping preferences and agreements for future product or service solicitations. Included in the request information would be information about one or more of the Customer's 1 designated Organization's With A Cause (OWC) and respective OWC ReplaCustom 2 web sites, that the Customer designates for receiving a credit associated with a donation or a purchase from a Preferred Product Vendor 8 or Associate Product Vendor 9. The Customer 1 may be asked to indicate if an OWC 2 may be credited independently of a purchase, as in the case of a donation. The Customer information provided as data through the Registered Customer 1A data entry window can then be stored in any JoBasic system, web site data base, for example in Marketing and Distribution Levels 1 1, under the control of the JoBasic system 100 and the information used to track a Registered Customer 1 transaction and properly credit each of the participating JoBasic system participants, for example the ROD 6, the Account Manager 5, or any other participating party. In addition, the credits may be managed responsive to multi-levels of participation related data or responsive to transaction related data such as total amount of purchases, price levels for respective transactions, and the quality or quantity of purchases or the timing of the purchases. This data may be stored in the Marketing Distribution Levels 11 or the Admin Panel 3 or the JoBasic system controller 7 or distributed on any suitable location in the JoBasic System 100, as would be known to those skilled in the art.

The OWC ReplaCustom 2 web site may communicate with the Account Manager 5 through path 24 for performance of any of the functions described herein with reference to a preferred embodiment, as described herein.

For the purpose of explanation, the Customer 1, after being registered in the JoBasic system 100, through the Registered Customer data entry window 1A, is now referred to as the Registered Customer or Customer 1.

In making a purchase, the JoBasic system 100 accounts for the selection of the vendor, the purchased item, the OWC credited and the amount or type of credit to be given.

The operation of the JoBasic system 100 is illustrated for a preferred embodiment by the following examples, which, as would be understood by those skilled in the art are not in limitation of equivalents to the claimed invention.

The JoBasic system 100 process starts with the Customer 1, making a purchase decision and in that decision, choosing to make the purchase at the OWC ReplaCustom web site 2, by data path 21, or through the JoBasic.com System Controller site 7 by path 27 or directly from the Preferred Product Vendor 8 by path 31 or from the Associate Product Vendor 9 by path 33. The Customer data relevant to identification and credit levels may be by a data base linked to a password or other suitable Customer 1 identification as would be known to those skilled in the art. Responsive to a purchase at an OWC site 2, data indicative of the purchase and of the Customer 1, is transmitted to the Admin Panel by data path 25 for Payment Processing 4 through data path 33. Payment processing alternatively may be from the Admin Panel 3 to the JoBasic.com site 7 to Payment Processing 4 by data paths 23, 33 and 35.

Payment authorization data may originate from the JoBasic.com site 7 for approval by any acceptable form of payment. This payment approval data is transmitted to an authorized payment gateway 13 by data path 36 from the JoBasic.com website 7, for approval and then returned by data path to the Admin Panel 3 and to Payment processing 4, by data path 23 for payment. Data responsive to the payment is sent from the Admin Panel 3 to the OWC ReplaCustom web site by data path 25, to the JoBasic.com site 7 by data path 23, to the ROD site 6 data path 37 and to the Account Manager site 5 by data path 39.

Payment may then be made under supervision of the Admin Panel 5, from the JoBasic Bank Account 10, after authorization by a standard payment gateway 13, or directly to the Vendors 8 and 9 through the Customer's chosen credit or debit card or other suitable system, as would be known to those skilled in the art. In a preferred embodiment, all funds cleared and collected thorough Payment Processing 4 is sent by data path 41 to the JoBasic Bank account 10. The Admin Panel 3 is used to control and calculate all banking functions according to the data in the Marketing and Distribution Levels data base 11. As would be known by those skilled in the art, Payment Processing 4, or the Marketing Distributing data base 11, may be combined in Admin Panel 3 and payment made to or from the JoBasic Bank Account 10 by data path 54 to the OWC ReplaCustom web site or through the Admin Panel 5 to the Vendors 8 and 9, by data paths 48 and 51.

Credits and payments may be made from the JoBasic Bank Account 10 to the ROD by path 47 or to the Account Manager 5 by path 49, under the control of Payment Processing 4 though path 41 or under the control of the Admin Panel 3 through path 43 The transfer of funds with respect to the Customer 1 can be by the Customer's chosen method off payment as described above or if payment is to be made through the JoBasic system 100, the credits with respect to the OWC ReplaCustom web site 2 and the ROD 6 and Account Manager 5, and to Vendors 8 and 9, can be accounted by the Admin Panel 3 and data indicative of these credits and payments can be provided as appropriate to the respective web sites.

The Administration Panel 3 may be used as the center of the data processing flow, as shown in a preferred embodiment. The Admin Panel 3 may be used to transmit information and data directly to the Product Vendors 8 and 9 for customer order fulfillment, reports and all support data. And the Product Vendors 8 and 9 can receive data from the Admin Panel 3, with respect to reports, product updates, shipping and any and all other types of data or information, by data paths 48 and 51.

Within the JoBasic system 100, the Admin Panel 3 will transmit data as known to those skilled in the art to communicate electronically to Vendors 8 and 9 and for tracking sales, data, statistics and for commissions owed JoBasic and all other JoBasic system 100 participants from sale of products to JoBasic customers through the Vendors 8 and 9.

The data which may be transmitted through the JoBasic System can include transaction, credit, marketing, and distribution, data related to a Customer 1, OWC ReplaCustom web site 2, ROD 6, Preferred and Associate Vendors 8 and 9 and would include emails, delivery confirmation, payment information and all other data and information a company would need to send customers or needed by the JoBasic system to account for payments and credits.

The credits due to the OWC's 2, ROD's 6 and Account Manager's 5 or any other commissioned levels such as network marketing commission structures are stored in data at the Admin Panel 3 and are transmitted on a periodic or occurring basis, daily, weekly or monthly.

The Marketing Distribution levels data base 11 is shown in a representative manner only to illustrate for a preferred embodiment, how the credit allowances for the separate respective system participants may be individually established according to any suitable marketing plan and it may be paced anywhere in the system it is accessible to the JoBasic System Controller 7 or the Admin Panel 3, or other processor in the JoBasic system requiring the data. The Marketing Distribution Levels may be algorithms or procedures for calculation of the credits due each participant with regard to sales levels, direct or indirect connections with the sales transactions, or active or passive connection with the sales transaction, as explained above.

As would be known to those skilled in the art, the inventive functions shown according to the disclosed inventive principles are not limited to a preferred embodiment, as shown but may be distributed or placed with any of the JoBasic system 100 participants, in accordance with the disclosed inventive principles.

1. A system for charity associated marketing comprising,
a) means for system control including means for identifying system participants;
b) said means for identifying system participants including means for identifying one or more customers or one or more organizations with a cause and for producing and recording transaction data related to said one or more customers or said one or more organizations with a cause;
c) means for data communication connecting said means for identifying one or more customers or for identifying one or more organizations with a cause;
d) said means for system control including means connected to said means for data communication for receiving transaction data indicative of transactions related to said one or more of customer or said one or more organization with a cause, for producing credit data indicative of at least a part of said transactions to be credited to a respective system participant.

2. The system of claim 1, wherein,
e) said means for producing credit data, for producing separate respective credit data for separate respective system participants or said credit data with separate respective credit allowances.

3. The system of claim 1, wherein,
f) said means for identifying system participants including means for identifying a account manager;
g) said means for producing credit data producing credit data indicative of at least a part of said transactions to be credited to said account manager.

4. The system of claim 2, wherein,
h) said means for producing separate respective credit data for separate respective system participants, directly producing said separate respective credit data from said transaction data or indirectly in response to said directly produced separate respective credit data.

5. The system of claim 2, wherein,
i) said means for producing credit data for producing separate respective credit data for separate respective system participants, including means for producing separate respective credit data in response to separate respective marketing levels.

6. The system of claim 2, wherein,
j) said means for producing separate respective credit data for separate respective system participants with separate respective credit allowances includes means for producing said separate respective credit data for vendors with a preferred presence relation with one or more system participants or for vendors with an associated presence relation with one or more system participants.

7. The system of claim 1, wherein,
k) said means for system control includes means for identifying said transactions with system participants acting in said transactions and system participants reacting to said transactions.

8. The system of claim 7, wherein, at least some of said s system participants reacting to said transactions receive credit data derived from credit data credited to said system participants acting in said transactions.

9. A data processing system for charity associated marketing, comprising,
a) a central data processing site connected to a communications system;
b) a customer data processing site connected to said communications system;
c) a plurality of organizations with a cause sites connected to said communications system;
d) said customer data processing site producing data indicative of a transaction for a designated respective organization with a cause, in response to a customer's purchase order or donation order, entered through said customer data processing site;
e) said central data processing site, responsive to said data indicative of transaction, producing organization with a cause credit data indicative of at least a part of or percentage of the amount of said transaction credited to said designated respective organization with a cause site; and
f) said central data processing site producing a record of said organization with a cause credit data.

10. The data processing system of claim 9, including,
g) an account manager site; and
h) said central data processing site responsive to said data indicative of a transaction, producing account manager credit data indicative of at least a part of or percentage of the amount of said transaction credited to said account manager site; and
i) said central data processing site producing a record of said account manager credit data.

11. The data processing system of claim 9, including,
i) a preferred vendor site connected to said communication system;
j) a associated vendor site, connected to said communication system;
k) said preferred vendor site related to said central processing site or to said plurality of organizations with a cause sites, by a primary communication link and said associated vendor site related to said central processing site or to said plurality of organizations with a cause sites, by a secondary communications link; and wherein,
l) said central data processing site, responsive to said data indicative of transaction, producing preferred vendor or associated vendor credit data related to said primary and secondary communications links.

12. A method of charity associated marketing comprising the steps of,
a) identifying system participants;
b) identifying one or more customers or one or more organizations with a cause and producing and recording transaction data related to said one or more customers or said one or more organizations with a cause; and
c) receiving said transaction data indicative of transactions related to said one or more customers or said one or more organization with a cause, for producing credit data indicative of a part of said transactions to be credited to a respective system participant.

13. The method of claim 12, wherein,
d) said step of producing credit data, producing separate respective credit data for separate respective system participants or said credit data with separate respective credit allowances.

14. The method of claim 12, wherein,
e) said step of identifying system participants includes the step of identifying an account manager; and
f) said step of producing credit data includes the step of producing credit data indicative of at least a part of said transactions to be credited to said account manager.

15. The method of claim 13, wherein,
g) said step of producing separate respective credit data for separate respective system participants includes the step of producing said separate respective credit data directly from said transaction data or indirectly in response to said credit data.

16. The method of claim 13, wherein,
h) said step of producing credit data, producing separate respective credit data for separate respective system participants or said credit data with separate respective credit allowances, includes the step of producing separate respective credit data for separate respective transactions.

17. The methd 13, wherein,
i) said step of producing credit data, producing separate respective credit data for separate respective system participants or said credit data with separate respective credit allowances, includes the step of producing said credit data for vendors with a preferred presence with one or more system participants or for vendors with an associated presence with one or more system participants.

18. The method of claim 12, including, wherein,
j) the step of identifying said transactions with system participants acting in said transactions and system participants reacting to said transactions.

19. The method claim 18, wherein,
k) at least some of said system participants reacting to said transactions receive credit data derived from credit data credited to said system participants acting in said transactions.

20. The method of claim 12, including the steps of,
l) identifying a primary vendor and an associate vendor, related to said transaction data, producing preferred vendor or associated vendor credit data related to said primary and secondary identification.
